(19) United States
(12) Patent Application Publication
(10) Pub. No.: US 2024/0291003 A1
(43) Pub. Date: Aug. 29, 2024

(54) INTEGRATED FUEL CELL AND COMBUSTION SYSTEM

(71) Applicants: UNM RAINFOREST INNOVATIONS, Albuquerque, NM (US); U.S. GOVERNMENT AS REPRESENTED BY THE SECRETARY OF THE AIR FORCE, Kirtland AFB, NM (US)

(72) Inventors: John Bryan PLUMLEY, Albuquerque, NM (US); Lok-kun TSUI, Albuquerque, NM (US); Thomas Liang-Shi PENG, Kirtland AFB, NM (US); Fernando GARZON, Santa Fe, NM (US)

(21) Appl. No.: 18/585,788

(22) Filed: Feb. 23, 2024

Related U.S. Application Data
(60) Provisional application No. 63/486,701, filed on Feb. 24, 2023.

(51) Int. Cl. H01M 8/04082; F23R 3/28; H01M 4/90; H01M 8/00; H01M 8/04014; H01M 8/12; H01M 8/1253; H01M 8/2425

(52) U.S. Cl. CPC H01M 8/04201; F23R 3/28; H01M 4/9033; H01M 8/004; H01M 8/04022; H01M 8/1253; H01M 8/2425; H01M 2008/1293

(57) ABSTRACT

An integrated fuel cell and combustion system that integrate both a fuel cell and a combustion system, such that the fuel cell and the combustion system share a a fuel source and an oxidizer source, and the fuel cell and combustion system can be utilized singularly or simultaneously based on the needs for power generation.

### CROSS-REFERENCE TO RELATED APPLICATIONS

This application claims the benefit of provisional U.S. patent application Ser. No. 63/486,701 filed Feb. 24, 2023, the disclosure of which is herein incorporated by reference in its entirety.

### GOVERNMENT INTEREST

This invention was made with government support under contract number 2RND7/2ND71/740291 awarded by the Air Force Research Laboratory and contract number CP0052645 awarded by the Air Force Research Laboratory. The U.S. Government has certain rights to this invention.

### TECHNICAL FIELD

The subject matter described herein relates generally to electricity generation, and more particularly to generating electricity via either a fuel cell, a combustion system, or both, by integrating a fuel cell and a combustion system.

### BACKGROUND

Chemical energy stored in devices and vehicles is a critical resource that often results in the end of operational lifetime when completely expended. The finite availability of this critical resource is further limited by how a device or vehicle is designed to utilize this chemical energy. A combustion system can tap the chemical energy in a fuel and oxidizer by igniting a mixture of these chemicals to create hot gases. These gases can then be used to provide torque to drive pistons in an internal combustion engine or provide thrust when released as the exhaust from a bipropellant rocket thruster. While diverse in its utility, fundamentally, igniting a fuel and oxidizer can only be used to drive pneumatics, create molecular flows, and provide heat. A combustion system could be used to generate electrical power by conducting operations such as driving a dynamo or running a thermoelectric generator. However, these approaches would be significantly less efficient than directly converting the available chemical energy into electrical power via a fuel cell.

A fuel cell can generate electrical power by electrochemically oxidizing a fuel while concurrently reducing an oxidizer. Such a system can be used to power electronics while still generating gases that can be used to drive pneumatics or released to provide thrust like a bipropellant thruster. Nonetheless, these nascent gases are not as effective at driving combustion applications since they are not formed as quickly or reach as high a temperature as gases produced from direct ignition. Therefore, there is a need for an improved power generation system that can generate energy as efficient as a fuel cell, and also be as effective at driving combustion applications as a combustion system.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

The integrated fuel cell and combustion system described herein is a combined electrochemical electrical power and combustion system. The integrated system includes a fuel cell component that can simultaneously run to generate electricity while its internal combustion components is running combustion driven functions.

Nonetheless, when appropriate, the integrated fuel cell and combustion system can be a dedicated internal combustion system only. The integrated system can bypass its fuel cell components and be used exclusively to conduct internal combustion driven functions, such as providing thrust if the combustion system is a bipropellant thruster, or providing torque, if the combustion system is an internal combustion engine.

Similarly, when appropriate, the integrated fuel cell and combustion system can also be a dedicated electrochemical electrical power supply only, such that the integrated system can bypass its combustion components and be used exclusively as an electricity generating fuel cell.

By combining fuel cell and combustion system in the same device, it is possible to consolidate the refueling process. Replenishing the fuel and oxidizer pair in the integrated system simultaneously refuels the fuel cell and internal combustion system. The integrated system has the flexibility to shift from consuming the available fuel and oxidizer to drive either the internal combustion system or the fuel cell, or both systems together, as needed.

This integrated fuel cell and combustion system can provide a high capacity electrochemical electrical power supply. The high energy density and specific energy of fuel cells allow them to store a great deal of electrical energy in a small lightweight package. By having a combustion system combined with the fuel cell, this integrated system is able to have an efficient power generation process, and also be effective at providing thrust or torque towards combustion applications as needed.

An exemplary integrated fuel cell and combustion system comprises a fuel cell having an anode, a cathode, and an electrolyte; a combustion system having a bipropellant thruster; a fuel source connected to the fuel cell and the combustion system; and an oxidizer source connected to the fuel cell and the combustion system.

An exemplary method of providing electrical power and thrust in an integrated fuel cell and combustion system comprises: providing an integrated fuel cell and combustion system that includes a fuel cell and a combustion system having a bipropellant thruster, and the fuel cell and combustion system are connected to a shared fuel source and a shared oxidizer source; determining how much electrical power and combustion thrust are desired; sending a fuel from the fuel source and an oxidizer from the oxidizer source to the fuel cell for electricity generation, the combustion system for combustion thrust generation, or to both the fuel cell and the combustion system; and capturing the electricity generated and an exhaust produced by the fuel cell for downstream use or for storage.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic drawing of a fuel cell that can be incorporated into an exemplary integrated fuel cell and combustion system described herein;

FIGS. 2A, 2B, 2C, 2D are schematic drawings of multiple views of an exemplary tubular fuel cell design that can be incorporated into an exemplary integrated fuel cell and combustion system described herein; and

FIG. 3 is a schematic drawing of an exemplary integrated fuel cell and combustion system.

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to the present examples, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure can be practiced. These implementations are described in sufficient detail to enable those skilled in the art to practice the present disclosure and it is to be understood that other implementations can be utilized and that changes can be made without departing from the scope of the present disclosure. The following description is, therefore, merely exemplary.

The integrated fuel cell and combustion system described herein is an improved device that combines an electrical power generating fuel cell with an internal combustion system to create a single integrated platform that is powered by a shared chemical energy reservoir. This device allows the chemical energy in the fuel and oxidizer stowed to drive a combustion system, such as an engine or a bipropellant thruster, to be reallocated to supply electrical power as needed.

If integrated in a vehicle, as an example, the integrated fuel cell and combustion system can provide operational flexibility on how chemical energy in a fuel and oxidizer stored in a device or stowed on a vehicle can used to optimize its expenditure. If only combustion functions are needed, an operator can maximize the efficiency of fuel and oxidizer consumption to support these functions by exclusively directing these chemicals to the combustion system components of the integrated fuel cell and combustion system which are optimized to run combustion functions. Alternatively, if mission needs only require electricity, an operator can maximize the efficiency of consuming the available fuel and oxidizer to support electricity production by exclusively directing these chemicals to the fuel cells, which are extremely efficient at converting chemical energy into electrical energy.

Additionally, since large amounts of gaseous fuels and oxidizers can be readily stored in a compact space by compressing them into low volume and high pressure storage tanks, an integrated fuel cell and combustion system can store a large amount of chemicals which can subsequently supply a large amount of electrical power. This capability can enable long durations of electronics use on missions even when replenishing the chemical energy, such as by recharging a battery, is not possible.

If operational needs require both electrical power and combustion functions, an integrated fuel cell and combustion system can be used to supply both simultaneously or just one of either system as needed. This can simplify reenergize operations by consolidating combustion system refueling and electrical power source recharging into a single fuel and oxidizer replenishment process. Moreover, an integrated fuel cell and combustion system can allow operators to shift chemical energy use to optimize its consumption between supporting combustion functions or electrical power production on the fly. Such a capability also frees manufacturers from having to choose between allocating limited mass and volume allotments in devices or vehicles between adding more fuel and oxidizers to drive combustion functions or batteries to power electronics. It can also allow operators to respond to unexpected electricity needs by allowing chemical energy originally allocated to drive internal combustion functions to be consumed by the fuel cell, or respond to unexpected combustion function needs by allowing chemical energy originally allocated to support electricity production to be redirected to run combustion functions.

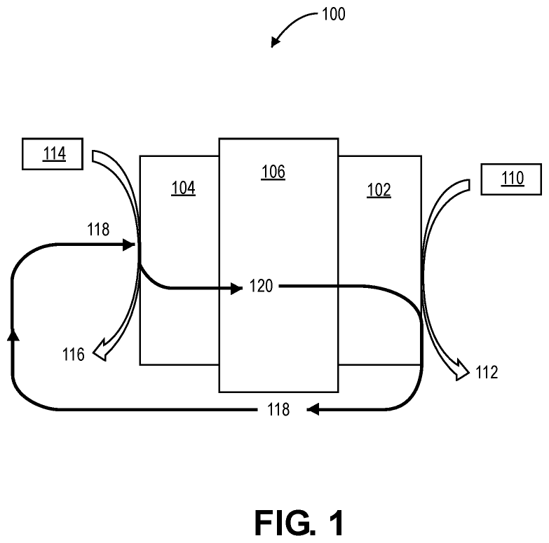

The integrated fuel cell and combustion system is a fuel cell, designed to generate electrical power by electrochemically consuming fuels and oxidizers used in bipropellant thrusters, that is integrated with a bipropellant thruster used for orbital maneuvering. FIG. 1 shows a schematic and generalized fuel cell 100. The fuel cell 100 includes an anode 102 and a cathode 104 that both abut an electrolyte 106 on two opposite sides of the electrolyte 106. A fuel 110 (such as bipropellant thruster fuels) is provided to the anode 102, and an oxidizer is provided to the cathode 104 for the electrochemical electrical power generation.

Examples of bipropellant thruster fuels which can be electrochemically oxidized by integrated fuel cell and combustion systems to generate electricity include hydrogen (H₂), ammonia (NH₃), and hydrazine (N₂H₄), including monomethylhydrazine, unsymmetrical dimethylhydrazine, dimethylhydrazine, or a combination thereof. Examples of oxidizers which can be reduced by integrated fuel cell and combustion systems to generate electricity include the oxygen (O₂) found in air, pure O₂, nitrous oxide (N₂O), dinitrogen tetroxide (N₂O₄), hydrogen peroxide (H₂O₂), dinitrogen dioxide (N₂O₄), or a combination thereof. NH₃ is of particular interest as it is significantly less toxic than fuels commonly used in bipropellant thrusters, and it is in liquid form at standard temperature and pressure (STP) which allows a large amount of NH₃ to be stored in a small volume. Similarly, N₂O is a notable oxidizer as it is non-toxic and a large amount of N₂O can be stored at room temperature since N₂O can be liquefied by pressurizing it to pressures above 52 bar.

When explosive chemical thrust is needed, a gas manifold system in the integrated fuel cell and combustion system delivers vaporized fuel 110 and oxidizer 114 to the bipropellant orbital maneuvering thruster. This allows the thruster to perform as designed and optimizes use of the available fuel and oxidizer to provide thrust. When electricity is needed, the integrated fuel cell and combustion system directs fuel and oxidizer to the fuel cell 100 to optimize use of the available fuel and oxidizer to provide electrical power. Exemplary fuel cells that could be used in the integrated fuel cell and combustion system include Solid-Oxide Fuel Cells (SOFC), Molten Carbonate Fuel Cells (MCFC), and Phosphoric Acid Fuel Cells (FAFC), or any kind of fuel cells that are stable and operable at high temperatures, including Proton Conducting Solid Oxide Fuel Cells (PC SOFC).

Electricity is produced in the fuel cell 100 when electrons 118 released by the electrochemical oxidation of the fuel 110 at the anode 102 is drawn through an electronic load. These electrons 118, upon exiting the electronic load, are subsequently used to electrochemically reduce the oxidizer 114 at the cathode 104. To complete this electrical circuit, migrating ions 120, such as oxygen (O²⁻) can be created, reduced, oxidized, or neutralized at the anode 102 and cathode 104.

When ions are generated at the anode 102, the ions produced are positively charged and their migration to the cathode 104 alleviates the positive charge created by the oxidation reaction at the anode 102. Concurrently, the reduction of ions at the cathode 104 counters the negative charge created by electrons 118 arriving at the cathode 104 from the electronic load. Conversely, when ions 120 are generated at the cathode 104, the ions 120 produced are negatively charged and their migration to the anode 102 alleviates the negative charge created by the reduction reaction at the cathode 104. Concurrently, the oxidation of ions at the anode 102 counters the positive charge created by the push of electrons 118 into the electrical load by the oxidation reaction at the anode 102. The anode byproduct 112 at the anode 102 and the cathode byproduct 116 at the cathode 104 would be removed from the fuel cell 100.

In an exemplary process, gaseous NH₃ is supplied as the fuel 110 to the anode 102, and gaseous N₂O is supplied as the oxidizer 114 to the cathode 104. In this example, Equation 1 details the NH₃ oxidation which occurs at the anode 102, with the anode byproduct 112 of H₂O and N₂, and Equation 2 details the N₂O reduction which occurs at the cathode 104, with the cathode byproduct 116 of N₂.

$$Anode : 2 {NH}_{3} ( g ) + 3 {O}^{2 -} \to 3 {H}_{2} O ( g ) + {N}_{2} ( g ) + 6 {e}^{-} \qquad ( 1 )$$

$$Cathode : 3 {N}_{2} O ( g ) + 6 {e}^{-} \to 3 {N}_{2} ( g ) + 3 {O}^{2 -} \qquad ( 2 )$$

Electrons 118 which are driven through the electrical load are produced at the anode 102 while negatively charged oxygen ions (O²⁻) 120, which migrate through the electrolyte 106 to complete the circuit, are produced at the cathode 104.

To overcome the large activation energy barrier to electrochemically reducing N₂O, the exemplary integrated fuel cell and combustion system utilizes a ceramic cathode composed of lanthanum strontium manganite oxide (LSMO) to catalyze the N₂O reduction and utilize its high temperature tolerance to operate at temperatures, specifically temperatures above 600° C., to allow the application of sufficient thermal energy to drive LSMO catalyzed N₂O reduction. Alternatively, other kinds of mixed ionic electronic conducting ceramics can be used as the cathode material, such as lanthanum strontium cobalt ferrite (LSCF) or chromite (LSCM).

Similarly, in the exemplary integrated fuel cell and combustion system, a nickel (Ni) anode is used to drive NH₃ oxidation since Ni can catalyze NH₃ oxidation and the 1,455° C. melting point of Ni can tolerate the 600° C. integrated fuel cell and combustion system operating temperatures needed to drive the N₂O reduction at the cathode. Alternatively, other mixed ionic electronic conducting ceramic structures could be used as the anode material, such as NiO, TiO₂, La₂O₃, CeO₂, MgO, Y₂O₃ and metals Ru, Cu—Co and Co. The anode material can also be mixed with electrolyte material, such as yttria-stabilized zirconia (YSZ).

In an exemplary integrated fuel cell and combustion system, O²⁻ migration is conducted through a solid state electrolyte composed of ceramic scandia doped zirconia (ScSZ). This ceramic electrolyte provides structural support and separates NH₃ from N₂O to prevent these gases from reacting together directly. Additionally, ScSZ is used since it can support O²⁻ migration and does not breakdown when heated to the 600° C. plus operating temperatures of the fuel cell. Other electrolytes could include yttria-stabilized zirconia (YSZ) and Gadolinium doped Ceria (GDC).

In the integrated fuel cell and combustion system, temperature tolerances of the anode, cathode, and electrolyte are between about 600° C. and about 1000° C. The gas pressures can be from between about 1 bar and about 8 bar.

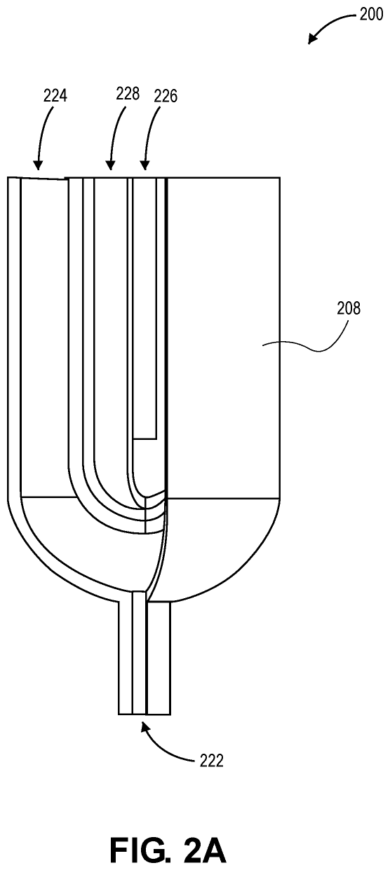

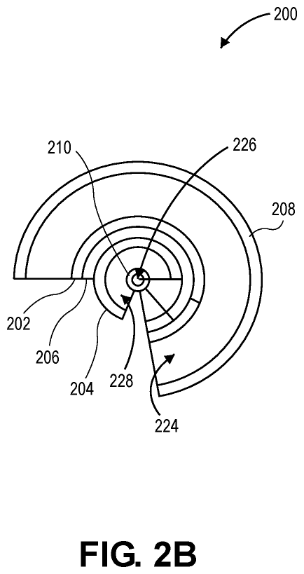

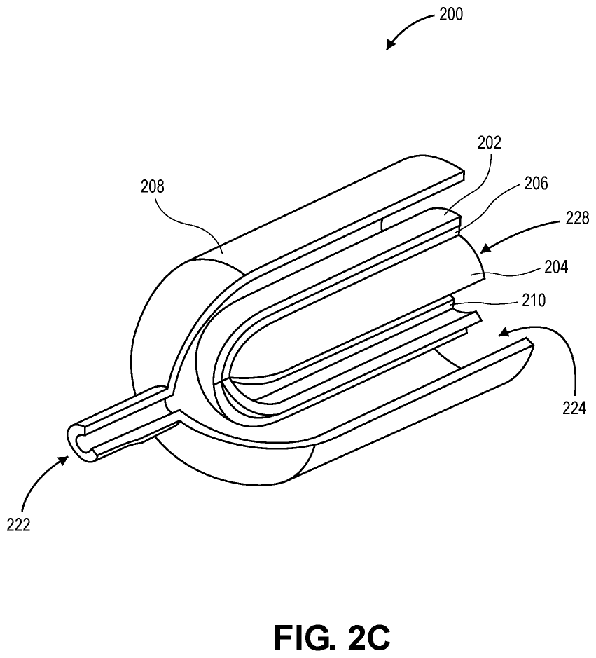

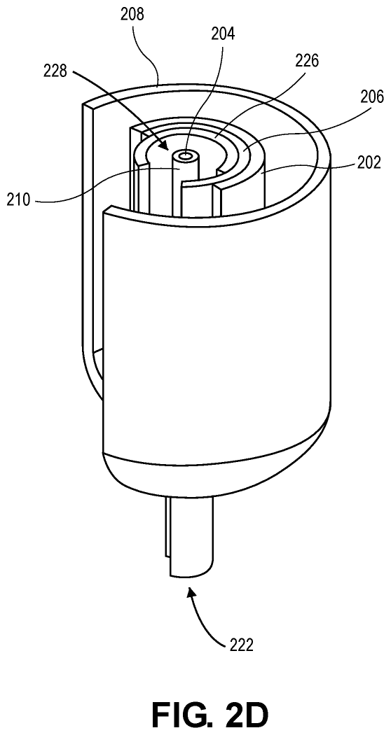

A schematic drawing of a tubular fuel cell design that can be utilized in an exemplary integrated fuel cell and combustion system is shown in FIGS. 2A, 2B, 2C and 2D. The tubular fuel cell 200 is in a tubular shape with an anode gas inlet 222 through an opening in the outer housing 208 of the tubular fuel cell 200, and an anode gas outlet 224 through another opening in the outer housing 208 that is on the opposite end of the outer housing 208 from the anode gas inlet 222. The anode gas inlet 222 and the anode gas outlet 224 are both spatially connected to the anode 202. The cathode gas inlet 226 is defined by an inner housing 210, and the cathode gas outlet 228 is provided in between the inner housing 210 and the cathode 204. An electrolyte 206 is sandwiched between the anode 202 and the cathode 204 inside the outer housing 208.

Diameters and lengths of the outer housing 208, the anode gas inlet 222, the cathode gas inlet 226, the anode gas outlet 224, and the cathode gas outlet 228 is determined depending on how much power is desired to be produced from the integrated system. More required power would require more electrode surface area, which could be achieved by either increasing the diameter or length of the cylindrical electrode with domed-shaped ends in FIG. 2, which in turn would require larger diameters for the outer housing and tubes.

Exemplary diameters of the anode gas inlet 222, the cathode gas inlet 226, the anode gas outlet 224 and the cathode gas outlet 228 include from about 0.5 mm to about 50 mm, more specifically from about 10 mm to about 25 mm, and exemplary diameter of the outer housing 208 includes from about 20 mm to about 610 mm, more specifically from about 250 mm to about 500 mm, with the possibility of designing the system to have smaller or larger diameters depending on system requirements. Exemplary fuel cell tube length includes from about 0.1 m to about 4 m, and more specifically about 2 m, with the possibility of designing the system to be shorter or longer than the specified range, depending on the system requirements. The diameters and lengths of the fuel cell may be limited by the area, volume, and mass limitations of a desired operation, such as being a part of a vehicle, spacecraft, etc.

In an exemplary tubular fuel cell design, the anode gas inlet 222 and the cathode gas inlet 226 are smaller in diameter than the anode gas outlet 224 and the cathode gas outlet 228. The anode gas inlet 222 and/or the cathode gas inlet 226 may be filled with a catalyst. In an example, a steel wool may be provided as a catalyst to accompany a NH3 fuel in the anode gas inlet 222, and a lanthanum strontium cobalt ferrite (LSCF) powder may be provided as a catalyst to accompany a N2O fuel in the cathode gas inlet 226.

The dome shape of the outer housing 208 conforms to the shape of the domed-end of the cylindrical shaped anode 202, and serves to expand the area of the anode gas inlet 222 to flow over the surface of the anode 202. The dome shape of the outer housing 208 allows the gas to have an aerodynamic flow over the domed end of the electrode 206. In addition, the domed shape of the electrode 206 provides more surface area as compared to a flat end.

In an alternative exemplary tubular fuel cell, the anode and cathode positions can be switched. In this alternative embodiment, the anode gas inlet and the anode gas outlet are spatially connected to the anode, such that the anode gas inlet is defined by the inner housing and the anode gas outlet is provided in between the inner housing and the anode. In turn, the cathode gas inlet and the cathode gas outlet are spatially connected to the cathode, such that the cathode gas inlet is defined by an opening in the outer housing and the cathode gas outlet is provided through another opening in the outer housing that is on the opposite end of the cathode gas inlet.

To manufacture an exemplary tubular fuel cell, the individual fuel cell 200 is made by first curing a thin wafer of solid state electrolyte 206. A thicker wafer is more structurally robust but imposes greater ohmic loss due to the extended distance ions must traverse to migrate from one catalytic electrode to the other. Conversely, a thinner wafer is structurally more fragile but the shorter distance between the catalytic electrodes (that is, the anode 202 and the cathode 204) incurs less ohmic loss.

Thicknesses of the cathode, the anode, and the electrolyte in the tubular fuel cell are determined by the composition of the electrodes and electrolyte. Exemplary cathode and anode thicknesses for an electrolyte supported cell may be between about 1 μm and about 1000 μm. Exemplary thicknesses of electrolytes in between the cathode and anode may be between about 1 μm and about 250 μm.

The anode 202 and the cathode 204 are affixed to two different surfaces of the solid state electrolyte 206 by depositing a thin layer of catalytic anode material on one face of the electrolyte 206, and a thin layer of catalytic cathode material on the opposite face of the electrolyte 206. The anode 202 and the cathode 204 are subsequently annealed to ensure good contact with the solid state electrolyte 206 to create the triple interface needed for fuel cell operation in the fuel cell 200. The first interface (the anode 202) accepts the fuel or oxidant. The second interface (the electrolyte 206) releases or accepts electrons to drive electrical current. The final interface (the cathode 204) releases or accepts ions to complete the electronic circuit.

Materials for the both the outer housing and the inner housing are chemically inert and can handle high temperatures, such as alumina and zirconia. In the exemplary embodiment, the outer housing and the inner housing are made of similar material. Alternatively, the outer housing and the inner housing may be made of two different materials. The thicknesses of the outer housing and the inner housing may be between about 0.1 mm to about 65 mm, and more specifically between about 10 mm to about 50.8 mm.

In an exemplary integrated fuel cell and combustion system, there are additional standard orbital maneuvering thruster and integrating valves that can redirect fuel and oxidizer to a fuel cell, such as one depicted in FIGS. 2A, 2B, 2C, and 2D, when electricity is needed. Exhausts generated by this fuel cell are subsequently directed back to the thruster for release. To achieve desired voltages, multiple fuel cells can be linked serially in a multi-cell stack until the desired voltage is researched. Similarly, to accommodate desired current loads, multiple fuel cells can be linked in parallel until there are sufficient cells to support the desired current demand.

Using an exemplary tubular fuel cell, a current load of between about 1 A and about 30 A could be achieved. In another example, a 5-cell stack of the exemplary tubular fuel cell may achieve about 5 V with 100 Watts of power using 0.8 standard liters per minute of NH₃ fuel flow and 4.6 standard liters per minute of N₂O flow. In an alternative example, a 72-cell stack of the exemplary tubular fuel cell may achieve around 80 V with 1 kW of power, using 9.5 standard liters per minute of NH₃ fuel flow and 10 standard liters per minute of N₂O oxidizer flow.

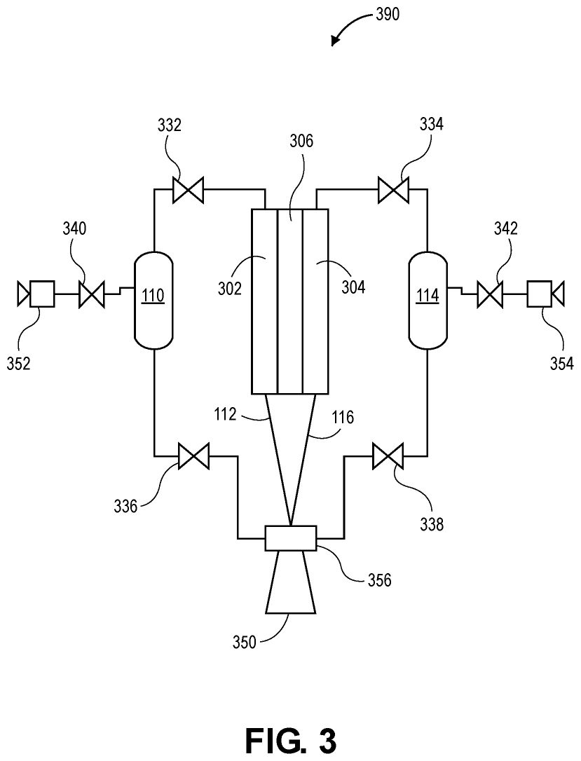

A schematic of how an exemplary fuel cell can be integrated with a bipropellant thruster is shown in FIG. 3. The integrated fuel cell and combustion system 390 includes a fuel cell stack having an anode 302 and a cathode 304, with an electrolyte 206 sandwiched in between the anode 302 and the cathode 204. The anode 302 is supplied with a fuel 110 that is connected to a fuel source 352. Similarly, the cathode 304 is supplied with an oxidizer 114 that is connected to an oxidant source 354. Valves 332, 334, 336, 338, 340 and 342 can be switched on and off together or separately for different operational needs. The thruster 350 can be turned on by different configurations of the valves 332, 334, 336, 338, 340 and 342 when needed.

When thrust 350 is needed, the integrated fuel cell and combustion system 390 can work like a traditional orbital maneuvering thruster by directing the fuel 110 and oxidizer 114 stored onboard to an ignition chamber where this mixture can be ignited. This ignition quickly generates a great deal of high pressure high temperature gas which can be released to provide large amount of rocket propulsion.

When electricity is needed, the integrated fuel cell and combustion system 390 can direct the fuel 110 and oxidizer 114 to the fuel cell to efficiently generate electricity. Exhaust from fuel cell operation, such as the anode exhaust 112 and the cathode exhaust 116, can similarly be released to provide rocket propulsion, however, the magnitude of this propulsion will typically be less than what can be provided via direct ignition. If only electricity is needed, the integrated fuel cell and combustion system 390 can store exhausts generated by the fuel cell stack at an exhaust storage 356. This exhaust can subsequently be released to provide rocket propulsion when needed, or the exhaust can be expelled in such a way as to provide no net thrust if the exhaust must be released but no maneuvering is desired.

In the exemplary integrated fuel cell and combustion system 390, to operate in fuel cell only mode to generate electricity, valves 332 and 334 are switched on to provide the fuel 110 to the anode 302 and provide the oxidizer 114 to the cathode 304. Valves 336 and 338 are switched off.

In the exemplary integrated fuel cell and combustion system 390, to operate in thrust only mode, valves 336 and 338 are switched on to provide full gas thrust from the stored fuel 110 and oxidizer 114 to the thruster 350. Valves 332 and 334 are switched off from the fuel cell stack.

In the exemplary integrated fuel cell and combustion system 390, if further thrust is needed to operate the integrated fuel cell and combustion system 390, valves 340 and 342 can be switched on additionally to provide cold gas thrust as desired.

To bring the fuel cell to operating temperatures (for example, for a solid state NH₃/N₂O fuel cell the temperature would exceed 600° C.), the integrated fuel cell and combustion system can either activate an electric heater or run the bipropellant thruster to generate heat that can be transferred to the fuel cell. Once active, the exothermic nature of the electrochemical reactions that occur during fuel cell operation can sustain minimum operating temperatures. Gas manifolds used in single and stacked fuel cells can also be throttled to provide improvements in electricity production efficiency over power or vice versa.

In addition to providing thrust and electricity, an integrated fuel cell and combustion system can be used to provide emergency cooling. To provide such cooling, an integrated fuel cell and combustion system can first circulates fuel and oxidizer over or through a heat sink that is additionally provided outside the fuel cell stack. This allows heat from the heat sink to be transferred to the fuel and oxidizer. This transferred heat can then be expelled from the system by releasing the heated fuel and oxidizer.

In another exemplary integrated fuel cell and combustion system, the integrated fuel cell and combustion systems can comprise of fuel cells integrated with combustion systems such as an internal combustion engine, a booster rocket, or an electrical generator.

### Example Fuel Cell System

In an integrated fuel cell and combustion system that utilize bipropellants as part of the combustion portion, NH₃ was investigated as a potential bipropellant fuel (and as proxy for N₂H₄, which is commonly used on spacecrafts), and N₂O was investigated as a potential bipropellant oxidizer (and as proxy for N₂O4, which is commonly used on spacecrafts). An exemplary tubular fuel cell of the integrated fuel cell and combustion system had been tested to investigate the fuel cell performance of a SOFC system supplied with NH₃ as fuel and N₂O as oxidizer as compared to a standard fuel cell supplied with H₂ and air.

A 20 mm diameter Solid-Oxide Fuel Cells (SOFC) was heated to 800° C. with a tube furnace. Ag mesh was used as a current collector and was in contact with the cathode and anode using Ag paste. Ag wire was used as an electrical lead between the Ag mesh and the potentiostat circuit. NH₃ fuel was provided to flow directly to the anode at 150 SCCM (controlled with a flow controller) through an alumina inner tubing, and the anode byproduct was exhausted through another alumina outer tubing. N₂O fuel was fed directly to the cathode through an alumina inner tubing at 75 SCCM (controlled with a flow controller), and the cathode byproduct was exhausted through another alumina outer tubing.

An appropriate potentiostat circuit was used to measure current, voltage, and impedance of the fuel cell from the Ag wire leads in contact with the anode and cathode of the fuel cell. Additionally, a small section of the alumina tube (the anode gas inlet) delivering the NH₃ fuel feed to the cell was packed with steel wool and heated, with an external tube furnace, between 300° C. and 1000° C. to induce NH₃ breakdown (cracking) that produced more H₂ fuel to improve cell performance. Also, a small section of the alumina tube (the cathode gas inlet) delivering the N₂O to the fuel cell was packed with LSCF powder and heated, with an external tube furnace, between 300° C. and 1000° C., to improve breakdown of N₂O, which produced more O₂ oxidizer to improve cell performance.

From the testing data gathered, it was found that a SOFC system supplied with NH₃ as the fuel and N₂O as the oxidizer was able to achieve a comparable performance to a standard fuel cell supplied with H₂ and air. The testing data from the exemplary fuel cell showed that an integrated fuel cell and combustion system using a SOFC system was able to run with a bipropellant fuel and a bipropellant oxidizer such that a combustion system was able to run along side the fuel cell.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An integrated fuel cell and combustion system comprising:
a fuel cell having an anode, a cathode, and an electrolyte;
a combustion system having a bipropellant thruster;
a fuel source connected to the anode and the combustion system; and
an oxidizer source connected to the cathode and the combustion system.

2. The system of claim 1, wherein the fuel sources supplies one of hydrogen, ammonia, hydrazine, monomethylhydrazine, unsymmetrical dimethylhydrazine, dimethylhydrazine, or combinations thereof.

3. The system of claim 1, wherein the oxidizer source supplies one of oxygen from air, pure oxygen, nitrous oxide, dinitrogen tetroxide, hydrogen peroxide, dinitrogen dioxide, or combinations thereof.

4. The system of claim 1 further comprising a gas manifold system that delivers a gaseous fuel from the fuel source and gaseous oxidizer from the oxidizer source to the combustion system.

5. The system of claim 1 further comprising an exhaust storage unit that is connected downstream to the fuel cell.

6. The system of claim 1, wherein the cathode is a ceramic cathode composed of lanthanum strontium manganite oxide, lanthanum strontium cobalt ferrite, or chromite.

7. The system of claim 1, wherein the anode is composed of nickel, NiO, TiO₂, La₂O₃, CeO₂, MgO, Y₂O₃, Ru, Cu—Co, or Co.

8. The system of claim 7, wherein the anode is mixed with yttria-stabilized zirconia (YSZ).

9. The system of claim 1, wherein the electrolyte is a solid-state electrolyte composed of ceramic Scandia doped zirconia.

10. The system of claim 1 further comprising more than one additional fuel cells that are connected in series or in parallel.

11. The system of claim 1, wherein the fuel cell includes a thin wafer of solid-state electrolyte with catalytic electrodes deposited onto two opposing surfaces of the electrolyte.

12. The system of claim 1, wherein the fuel cell has a tubular shaped housing that encloses the cathode, the electrolyte, and the anode, as well as a cathode gas inlet, a cathode gas outlet, an anode gas inlet and an anode gas outlet.

13. The system of claim 12, wherein the anode gas inlet and the cathode gas inlet are filled with a catalyst.

14. The system of claim 1, wherein the combustion system is one of a bipropellant orbital maneuvering thruster, an internal combustion engine, a booster rocket, or an electrical generator.

15. A method of providing electrical power and thrust in an integrated system, comprising:
providing an integrated fuel cell and combustion system that includes a fuel cell and a combustion system that are connected to a shared fuel source and a shared oxidizer source;
sending a fuel from the fuel source and an oxidizer from the oxidizer source to one of the fuel cell for electricity generation, the combustion system for combustion thrust generation, or to both the fuel cell and the combustion system; and
capturing the electricity generated and an exhaust produced by the fuel cell for downstream use or for storage.

16. The method of claim 15, wherein the fuel cell is formed by curing a thin wafer of solid-state electrolyte, and depositing a thin layer of a first catalytic electrode on a first surface of the electrolyte, and depositing a thin layer of a second catalytic electrode on a second opposing surface of the electrolyte.

17. The method of claim 15 further comprising more than one additional fuel cells that are connected in series or in parallel to each other.

18. The method of claim 15 further comprising using a gas manifold system to deliver vaporized fuel from the fuel source and oxidizer from the oxidizer source to the combustion system.

19. The method of claim 15, wherein the combustion system is one of a bipropellant orbital maneuvering thruster, an internal combustion engine, a booster rocket, or an electrical generator.

20. The method of claim 15 further comprising preheating the fuel cell before electricity generation by supplying fuel to the combustion system to generate heat that is transferred to the fuel cell.
